(19) United States
(12) Patent Application Publication
(10) Pub. No.: US 2009/0138562 A1
(43) Pub. Date: May 28, 2009

(54) METHOD AND SYSTEM FOR AGGREGATION OF ELECTRONIC MESSAGES

(75) Inventors: Mark J. Schmulen, Houston, TX (US); David D. Lyman, Houston, TX (US); Scott F. Mury, Houston, TX (US)

Correspondence Address: HAYNES AND BOONE, LLP;IP Section, 2323 Victory Avenue, Suite 700, Dallas, TX, 75219, US

(73) Assignee: LOYAL TECHNOLOGY SOLUTIONS, L.L.C., Houston, TX (US)

(21) Appl. No.: 11/946,537

(22) Filed: Nov. 28, 2007

(51) Int. Cl. G06F 17/30

(52) U.S. Cl. 709/206

(57) ABSTRACT

A system and method for aggregating and delivering electronic messages is provided. The method includes periodically retrieving electronic messages associated with a single user from a plurality of source electronic mail servers via an aggregation server, storing the retrieved messages from the plurality of source electronic mail servers in an aggregated message store, generating an aggregated electronic mail message containing an aggregated list of the retrieved messages, and delivering the aggregated electronic mail message to a single destination mailbox for retrieval by the user as a single e-mail message, wherein the aggregated electronic mail message contains at least a portion of each of the retrieved electronic messages.

### FIELD OF THE INVENTION

Embodiments of the invention relate to electronic messaging and communication systems message aggregation and delivery.

### BACKGROUND OF THE INVENTION

Electronic mail systems (“e-mail”) refers to systems that allow messages to be sent between sites on a network utilizing Simple Mail Transfer Protocol (“SMTP”) over data links. The most widely used e-mail system is based on the Internet, a worldwide network of interconnected computer networks that communicate through Transmission Control Protocol/Internet Protocol (“TCP/IP”). In the Internet based system, any user connected to the Internet generally has the ability to send e-mail messages to any other user having an e-mail account that is also connected to the Internet.

In order to use e-mail, generally a user obtains an e-mail account through an e-mail service provider. E-mail service providers include most Internet Service Providers (“ISP”) (e.g., Roadrunner, Comcast, etc.) as well as web-based e-mail (“webmail”) providers (e.g., Google's Gmail, MSN's Hotmail, or Yahoo's Yahoo Mail). In addition, most companies offer e-mail accounts to employees that are either hosted on company servers or through an external application service provider. Most e-mail service providers offer a web-based e-mail client that can be accessed via a web browser through the Internet to facilitate the composing, sending, receiving, and storing of messages with an electronic mailbox (“mailbox”). However, many users utilize an e-mail client software application (e.g., Microsoft's Outlook, IBM's Lotus Notes) to access their electronic mailboxes.

When a user sends an e-mail using an electronic mailbox, the sender's e-mail client communicates with the sender's mail server, which then delivers the message across the Internet to a recipient's mail server, where the message is deposited and stored in the recipient's electronic mailbox as a new incoming e-mail. Electronic mailboxes are connected through the Internet and their associated mail servers generally use SMTP to send and receive messages, which once received, are stored in a message store. E-mail client applications connect to remote mail servers over the Internet via a modem or direct connection (e.g., DSL, cable modem, T1) and typically utilize protocols such as Post Office Protocol, Version 3 (“POP3”), Internal Message Access Protocol (“IMAP”), or Messaging Application Programming Interface (“MAPI”) to retrieve messages from the message store. In contrast, many webmail services provide users access to the contents of their mailboxes through a web interface that may be hosted on a web server and accessible using a web browser that communicates with the web server using Hyper Text Transfer Protocol (HTTP).

E-mail has evolved into a conventional form of both personal and work-related communication. The proliferation of e-mail messaging and the widespread availability of free and low-cost e-mail accounts have created an environment where many users utilize multiple e-mail accounts. Many users utilize multiple e-mail accounts as a way to compartmentalize their communications. For example, a user may restrict use of his/her work e-mail account for business matters and use a separate account for personal communications. Third accounts are often used as a repository for lower priority communications, including promotional and special-interest newsletters. It is not uncommon for some users to have up to ten or more e-mail accounts. However, as a consequence of having multiple accounts, it has become difficult for users to manage and retrieve messages from multiple e-mail accounts.

There are essentially three approaches for a user to access messages from multiple accounts. The simplest method is for a user to access each account's electronic mailbox via a web browser (e.g., Internet Explorer, Firefox), by signing into each account separately, using credentials associated with each account. Through this method a user may access one account's mailbox at a time by signing into a web-based e-mail service (e.g., Google's Gmail) to check messages and then signing into another mailbox (e.g., MSN's Hotmail) to check messages in that account. This method is relatively inconvenient because it does not allow users to view multiple accounts through a single interface and consequently requires the user to login to each account separately. In addition, due to security risks and legal liabilities, many companies restrict employee access to web-based mailboxes. This is largely because it is difficult for companies to monitor user activity on such sites and due to threat of a user potentially exposing company computing systems to viruses and other intrusions that may be attached to a message. Consequently employees subject to such restrictions cannot access their personal e-mail account mailboxes through their employer's computing systems using this method.

The second method is to synchronize multiple accounts through e-mail client software on a desktop computer (such applications may include Lotus Notes, Outlook, Eudora, or Thunderbird) or on a mobile device (such applications include Pocket Outlook for Windows Mobile, BlackBerry Internet Service Email for BlackBerry, or VersaMail for Palm). While most e-mail client software applications allow users to integrate multiple accounts and therefore access all their messages through a single interface, adding e-mail accounts can be difficult and frustrating for a user who is not technically proficient. Adding e-mail accounts to such software generally require a user to provide information he/she may not know, including the address, type and port number of the e-mail service provider's incoming mail server (e.g., POP3, IMAP, MAPI), as well as for the outgoing SMTP mail server. In addition, many webmail service providers do not enable POP3 or IMAP access and therefore cannot be integrated or require additional applications or proxies to integrate with most e-mail client software. Lastly, many corporations do not allow employees to integrate personal e-mail accounts with company software.

A third and relatively new approach for providing e-mail management for a user with multiple e-mail accounts is to use a messaging aggregation and delivery system that may include one or more aggregation mail servers. Through this method, an aggregation mail server connects to multiple source mailbox accounts and consolidates the messages in an aggregated message store. The aggregation mail server(s) log into the existing source mail servers on behalf of the user, using credentials set up by the user, retrieves the messages from the account, and stores copies of the messages in an aggregated message store. Users can then access their messages located in the aggregated message store through a mailbox, usually hosted on the Internet and accessed through a web-based user interface that displays aggregated messages from the user's multiple source e-mail accounts.

Although using a messaging aggregation and delivery system is potentially helpful for users who have multiple e-mail accounts and value the ability to access all their e-mail messages from a single user interface mailbox, there are significant drawbacks. Because a user of messaging aggregation and delivery systems is required to access his/her messages through a web-browser, a user with limited or restricted access to a web browser will not be able to utilize this method. Consequently, employees subject to restrictive corporate e-mail policies will most likely be prohibited from accessing an aggregated mailbox through a web browser. Lastly, a user who utilizes an e-mail client software application may find it inconvenient to access his/her personal e-mail messages through a web browser.

Despite the before mentioned methods for a user to access messages from multiple source e-mail accounts, further advancements that can address some of the limitations of the prior-art may be desired.

### SUMMARY OF THE DISCLOSURE

Exemplary embodiments described herein may provide an improved communication system for aggregating messages from multiple source e-mail accounts that can be retrieved by a user through a single interface which may be accessed via a web browser or other methods that are readily available to nearly all e-mail users.

Exemplary embodiments described herein may provide an improved communication system for a user to access electronic messages from multiple e-mail accounts when subject to restricted access to web-based mailboxes or prohibitions from integrating multiple e-mail accounts with an e-mail client software application.

Exemplary embodiments described herein may provide a communications system which may include a plurality of source mailboxes and multiple source mail servers for storing messages associated with each source e-mail account and an aggregation mail server having an associated web-based e-mail client. The aggregation mail server may periodically retrieve messages from a user's source mail servers on behalf of a user, using credentials provided by the user, and then store the messages in an aggregated message store associated with the aggregation mail server. A web-based mailbox may be accessed by the user through a web browser to retrieve and view aggregated messages that were originally sent to the source mailboxes.

Exemplary embodiments described herein may provide a method for a user to access messages from multiple source mailboxes that does not require the user to access a mailbox via a web browser. The method may include sending to one of the user's existing mailboxes (the “Destination Mailbox”), as defined by the user, an aggregated electronic mail message (the “E-mail Update”) that provides an interface for the user to access and view all messages that were sent to his/her other source mailboxes (the “Source Mailboxes”). The e-mail update sent to the user's destination mailbox may incorporate an easy-to-read format that lists messages that were originally sent to the user's source mailboxes. The format of the e-mail update may display the e-mail service provider name and user's mailbox address associated with each source mailbox and a list of all messages sent to each source mailbox. The list of messages sent to each source mailbox may include but is not limited to the following fields associated with the header information of each message: “Sender Name”, “Sender E-mail Address”, “Subject,” “Timestamp.” A user may use a pointing device, such as a mouse pointer to click on the Subject field of a particular message, which may contain a hyperlink that accesses a specific Uniform Resource Locator (“URL”) via a web browser to display the body/content associated with the particular message.

The e-mail update may be sent to a user on a recurring basis as defined by the user's preferences. The user may select but is not limited to receive the e-mail update as often as every hour on a daily basis or as seldom as once week. The messages displayed in each e-mail update may list any number of messages received by each source mailbox. The specific messages displayed could either be the messages that arrived since the previous e-mail update was sent to the user's destination mailbox, the messages received by the source mailboxes within a given period of time, or a specified number of messages most recently received by the source mailboxes.

In order to utilize the exemplary methods for messaging aggregation and delivery, a user will generally enroll and activate the service offered by a messaging aggregation and delivery service provider (the “Message Aggregation Service Provider” or “MASP”). A user may enroll and activate the service by accessing the MASP's website located on the Internet via a web browser. A user will generally first create an account with the MASP by submitting information to the MASP that will be stored on the MASP's servers and databases. A user may provide to the MASP information that includes but is not limited to the following: destination mailbox address, a unique password associated with the user's MASP account, any number of source mailbox addresses and passwords associated with each source mailbox account. In addition, the user may select specific delivery options so that the MASP knows when to send the e-mail update to the user's destination mailbox. To activate the service, a user may be required to agree to certain terms and conditions, validate his/her information and confirm his/her selections. The user may, at any time, access the MASP's website via a web browser to modify or delete any user-provided information or to cancel or temporarily suspend services offered by the MASP. The user may also access the MASP's website by selecting a navigation tool that may contain the name “My Account” that may be located in any e-mail update sent to the user's destination mailbox. The My Account navigation tool may contain a hyperlink that may direct the user to his/her personal account site located on the MASP's servers via a web browser.

The inventors note that the phrase/term source mailboxes may include, but is not limited to mailboxes associated with e-mail messages, messages sent through Social Networks (e.g, MySpace, Facebook, LinkedIn), messages sent as Short Message Service (SMS) through mobile devices, transcribed voicemail messages, visual voicemail messages and the like. As such, embodiments are not intended to be limited to traditional e-mail configurations, as the technology is equally applicable to nearly all electronic messaging technologies where a single user may have multiple accounts.

While the information contained in the e-mail update may be sent as an electronic message to a user's destination mailbox, it may also be sent to a user's client mobile device utilizing Short Message Service (SMS). Additionally, the data of the e-mail update may be accessed by a single user as a web Widget application, a Really Simple Syndication (RSS) feed or a Wireless Application Protocol (WAP) page. Finally, the data could also be accessible from a proprietary application created by the MASP, installed on the user's client computing device or mobile device.

Therefore, exemplary embodiments may generally provide a system and method for aggregating and delivering electronic messages is provided. The method generally includes periodically retrieving electronic messages associated with a single user from a plurality of source electronic mail servers via an aggregation server, storing the retrieved messages from the plurality of source electronic mail servers in an aggregated message store, generating an aggregated electronic mail message containing an aggregated list of the retrieved messages, and delivering the aggregated electronic mail message to a single destination mailbox for retrieval by the user as a single e-mail message, wherein the aggregated electronic mail message contains at least a portion of each of the retrieved electronic messages.

Exemplary embodiments described herein may further provide a communications system for aggregating electronic messages. The communications system generally includes a website configured to allow a user to enroll in an aggregation service, a plurality of source mailboxes and a plurality of source mail servers for storing messages associated with a plurality of source e-mail accounts associated with the user, an aggregation server and user agent configured to periodically retrieve a user's messages from the plurality of source message servers utilizing POP3, IMAP, or MAPI protocols, and a webmail proxy for retrieving messages and sending messages utilizing HTTP protocol. The communications system may further include a message store for storing aggregated messages retrieved from the plurality of source mailboxes, a database server for maintaining user preferences, source mail server connection parameters, and list of message headers associated with messages retrieved from the source mailboxes, an outgoing mail server for sending e-mail messages to a destination mailbox address utilizing SMTP protocol, and a destination mailbox for any given user to receive and retrieve e-mail messages.

Exemplary embodiments described herein may further provide an aggregated e-mail update message. The message may include an aggregated electronic mail message containing a list of messages received from a plurality of source mail servers associated with a single user, the message containing a plurality of navigation tools which may include the tools “Delete,” “Reply” or “My Account,” wherein the list of messages are categorized by the source mailbox associated with each message, and the list of messages are listed in a format that includes sender name, sender e-mail address, subject line, and timestamp associated with each message. The message may further include a subject line associated with each message and containing a hyperlink to redirect the user to a URL via a web browser to view a body of a particular message associated with the particular subject line, the sender name and sender e-mail address containing a “mail to” hyperlink associated with the e-mail address of the particular sender so that the user may reply to the particular sender through the destination mailbox, the source mailbox name containing a hyperlink to redirect the user to a site via a web browser to view a mailbox client associated with a particular source mailbox.

### BRIEF DESCRIPTION OF THE DRAWINGS

FIG. 1 illustrates a schematic block diagram illustrating an exemplary computer system suitable for implementing desktop (e.g., e-mail client) and server (e.g., mail server) components of an exemplary embodiment of the electronic mail system of the invention;

FIG. 2 illustrates a schematic block diagram of an exemplary software/firmware system suitable for controlling operation of the computer system of FIG. 1;

FIG. 3 illustrates a schematic block diagram of an exemplary architecture of an electronic mail system of the invention;

FIG. 4 illustrates an exemplary implementation of the Messaging Aggregation and Distribution System of the invention;

FIG. 5 illustrates a schematic block diagram of an exemplary Messaging Aggregation and Distribution System of the invention;

FIG. 6 illustrates a flow diagram of an exemplary user Registration Process of the invention;

FIG. 7 illustrates a flow diagram of an exemplary Messaging Aggregation and Distribution process of the invention;

FIG. 8 illustrates an exemplary e-mail update generated by an embodiment of the invention; and

FIG. 9 illustrates an exemplary e-mail message window generated by an embodiment of the invention.

### DETAILED DESCRIPTION OF THE DISCLOSURE

Prior to addressing the specific exemplary embodiments described herein, Applicants note that it is to be understood that the following disclosure provides many different embodiments, or examples, for implementing different features of various embodiments of the invention. The exemplary embodiments described herein discuss components and arrangements only as examples, and are of course, not intended to be limiting. In addition, the present disclosure may repeat reference numerals or letters in the various exemplary embodiments. This repetition is for the purpose of simplicity and clarity and does not in itself dictate a relationship between the various embodiments or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Similarly, method steps or program step execution sequences that are not expressly recited as being in a specific order may be conducted in various sequences and are not intended to be limited by the order in which they are described in the exemplary embodiments of the invention discussed herein. Similarly, method steps or program step execution sequences that are recited in the exemplary embodiments as being conducted in a particular order may be conducted in various sequences and are not intended to be limited by the order in which they are described in the exemplary embodiments discussed herein.

Further, embodiments of the invention may be implemented in a server-side application operating in an Internet-connected environment running under a network operating system, such as Microsoft Windows XP running on a client computing device, or an IBM-compatible PC. The invention, however, is not limited to any particular one application or any particular environment, as the embodiments illustrated herein are recited as and intended to be merely exemplary of the invention and not limited upon the application or environment of the invention. Those skilled in the art will find that the system and methods of the invention may be advantageously embodied on or in a variety of configurations, implementations, and platforms, including Linux, FreeBSD, Solaris, UNIX, and the like.

Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

The following discussion is directed to various exemplary embodiments of the invention. Although one or more of these exemplary embodiments may be preferred, the exemplary embodiments disclosed herein should not be interpreted, or otherwise used, as limiting the scope of the disclosure, including the claims, unless otherwise expressly stated herein. The discussion of any exemplary embodiment is meant only to be illustrative of that exemplary embodiment, and not intended to intimate that the scope of the disclosure, including the claims, is limited to that particular exemplary embodiment.

Further, at least one exemplary embodiment of the present disclosure may be implemented as a program product for use with a computer system or other type of processing device. The program product may generally be configured to define functions of the embodiments (including the methods) described herein and may be contained on any number of a variety of computer readable media. Illustrative computer readable media include, without limitation, (i) information permanently stored on non-writable storage media (e.g., read-only memory devices within a computer such as CD-ROM disks readable by a CD-ROM drive, or programmable logic devices); (ii) alterable information stored on writable storage media (e.g., floppy disks within a diskette drive or hard-disk drive, writable CD-ROM disks and DVD disks, zip disks, and writable portable memory devices); and (iii) information conveyed across communications media, (e.g., a computer, telephone, wired network, or wireless network). These embodiments also include information shared over the Internet or other computer networks, systems, and computers. Therefore, Applicants intend that any computer readable media, when carrying computer-readable instructions that are capable of performing methods or operations associated with the embodiments of the present disclosure when the instructions are executed by a processor, represent an exemplary embodiment of the present disclosure.

Further still, in general, software routines implementing various elements, parts, or embodiments of the present disclosure may be included as part of a computer operating system or as part of a specific application, component, program, module, object, or sequence of instructions, such as an executable script. Software routines typically include a plurality of instructions capable of being performed using a computer system or other type of processor configured to execute instructions read from a computer readable medium. Also, programs typically include or interface with variables, data structures, other computer programs that reside in a memory or on storage devices as part of their operation. In addition, various programs described herein may be identified based upon the application for which they are implemented. Those skilled in the art will readily recognize, however, that any particular nomenclature or specific application that follows facilitates a description of embodiments of the present disclosure and does not limit the embodiments for use solely with a specific application or nomenclature. Furthermore, the functionality of programs described herein may use a combination of discrete modules or components interacting with one another. Those skilled in the art will recognize, however, that different embodiments may combine or merge such components or modules in a variety of ways not expressly recited in the exemplary embodiments described herein.

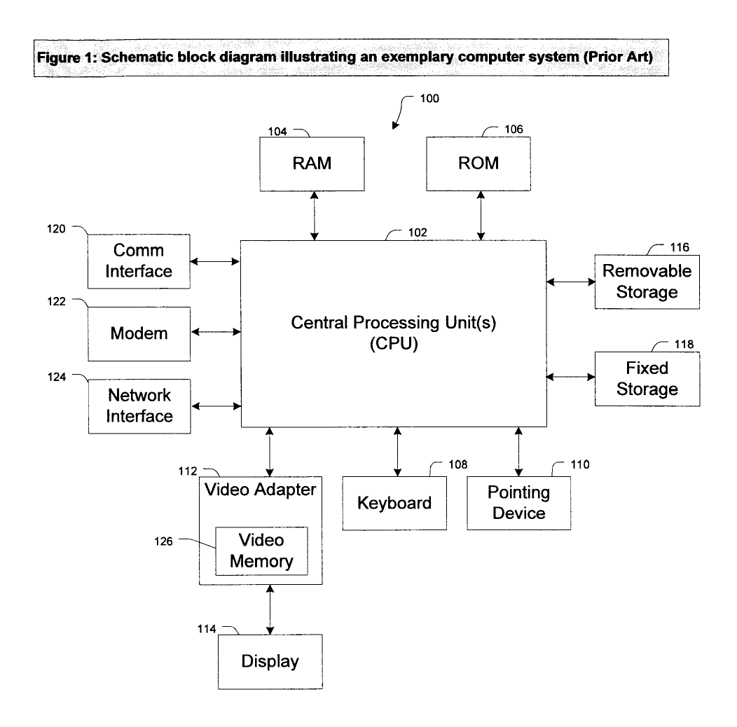

In an exemplary embodiment of the invention, the invention may be implemented on a conventional or general-purpose computer system, such as an IBM-compatible personal computer (PC) or server computer, for example. FIG. 1 illustrates a block diagram of an exemplary computer system 100 configured to implement embodiments of the invention, which may be but is not limited to an IBM-compatible system. The exemplary system 100 includes a central processor unit(s) (CPU) 102 coupled to a random-access memory (RAM) 104, a read-only memory (ROM) 106, a keyboard 108, a pointing device 110, a display or video adapter 112 connected to a display device 114, a removable (mass) storage device 116 (e.g., floppy disk), a fixed (mass) storage device 118 (e.g., hard disk), a communications port(s) or interface(s) 120 (e.g., universal serial bus), a modem 122, and a network interface card (NIC) or controller 124 (e.g., Ethernet). Although not shown separately, a real-time system clock may also be included with the system 100.

CPU 102 generally includes a processor, which may be of the Intel Pentium R™ family of microprocessors. However, any other suitable microprocessor or microcomputer may be utilized for implementing the various embodiments of the disclosure. The CPU 102 generally communicates with other components of the system via a bidirectional system bus (including any necessary input/output controller circuitry and other “glue” logic). The system bus, which includes address lines for addressing system memory, provides data transfer between and among the various components. Description of Pentium-class microprocessors and their instruction set, bus architecture, and control lines is available from Intel Corporation of Santa Clara, Calif.

RAM 104 generally operates as the working memory for the CPU 102. In a typical configuration, RAM 104 of one gigabyte or more is typically employed. More or less memory may be used without departing from the scope of the invention. The ROM 106 contains the basic input/output system code (BIOS), which is generally a set of low-level routines in the ROM that application programs and the operating systems can use to interact with the hardware, including reading characters from the keyboard 108.

Mass storage devices 116, 118 provide persistent storage on (generally) fixed and removable media, such as magnetic, optical or magnetic-optical storage systems, flash memory, or any other available mass storage technology. The mass storage 116, 118 may be shared on a network or it may be a dedicated mass storage 116, 118. As shown in FIG. 1, fixed storage 118 is configured to store a body of program and data for directing operation of the computer system, including an operating system, user application programs, driver and other support files, as well as other data files of all sorts. Typically, the fixed storage 118 operates as the main memory device or hard disk for the system 100.

In operation, program logic may be loaded from the storage device or mass storage 118 into the main (RAM) memory 104, for execution by the CPU 102. During operation of the program logic, the system 100 may accept user input from a keyboard 108 or a pointing device 110 or any other suitable user input device. The keyboard 108 generally permits selection of application programs, entry of keyboard-based input or data, and selection and manipulation of individual data objects displayed on the display device 114. Likewise, the pointing device 110, such as a mouse pointer, touch pad, or the like, permits the selection and manipulation of objects on the display device 114, In this manner, these input devices support manual user input for any process running on the system.

The computer system displays text or graphic images and other data on the display device 114. Display device 114 is generally driven by a video adapter 112, which is interposed between the display device 114 and the system 100. The video adapter 112, which may include video memory 126 accessible to the CPU, provides circuitry that converts pixel data stored in the video memory 126 to a raster signal suitable for use by the display device 114, which may be a cathode ray tube (CRT) raster or liquid crystal display (LCD) monitor.

The system 100 itself communicates with other devices (e.g., other computers) via the network interface card (NIC) 124 connected to a network (e.g., Ethernet network), or Modem 122 (e.g., 56K baud, ISDN, DSL, or cable modem), examples of which are available from 3Com of Santa Clara, Calif. The system 100 may also communicate with local occasionally-connected devices (e.g., universal serial bus cable-linked devices) via the communication (“Comm”) interface 120, which may include an RS-232 serial port, a Universal Serial Bus (USB) interface, or the like. Devices that will be commonly connected locally to the Comm Interface 120 include smartphones, handheld organizers, digital cameras, and the like.

IBM-compatible personal computers and server computers are available from a variety of vendors. Relative vendors include but are not limited to Dell Computers of Round Rock, Texas, Hewlett Packard of Palo Alto, Calif., and IBM of Armonk, New York.

The above-described system 100 of FIG. 1 is presented for purposes of illustrating the basic hardware underlying desktop (client) and server computer components that may be employed in the system of the invention. For purposes of discussion, the following description will provide examples in which it will be assumed that there exists a client machine (e.g., desktop “PC”) having application software locally that, in turn, is connected to a “server” or remote device having services or information of interest to the ultimate end-user. The invention, however, is not limited to any particular environment or device configuration. In particular, a client/server distinction is neither necessary to the invention nor even necessarily desirable, but is used to provide a framework for discussion. Instead, the invention may be implemented in any type of computer system or processing environment capable of supporting the methodologies of the invention described in detail below.

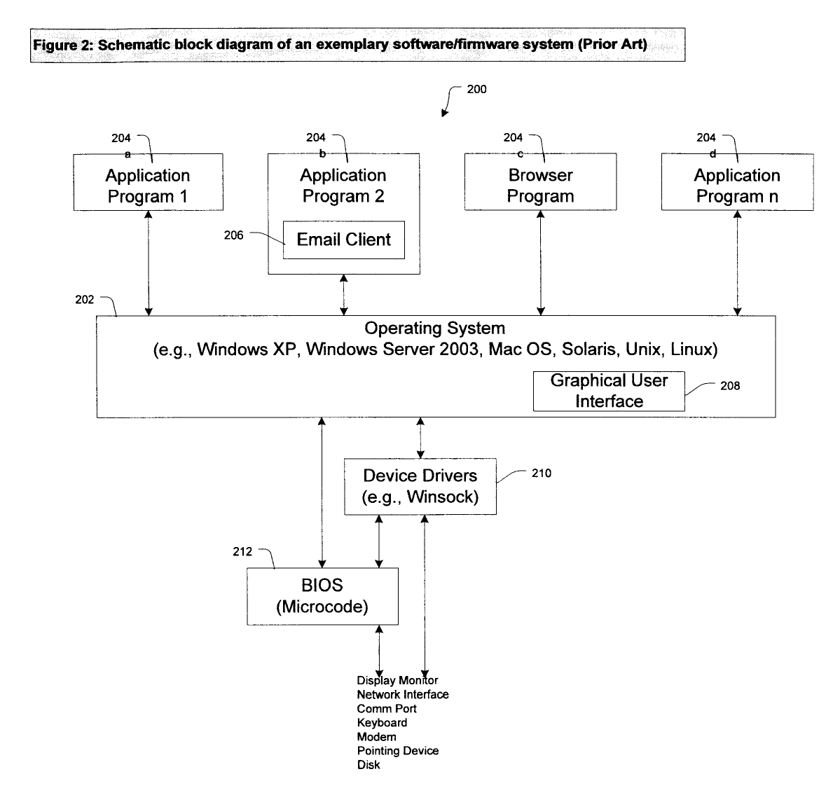

Illustrated in FIG. 2, a computer software system 200 is provided for directing the operation of the computer system 100. Software system 200, which is stored in system memory (RAM) 104 and on fixed storage (e.g., hard disk) 118, includes a kernel or operating system (“OS”) 202. The OS 202 manages low-level aspects of computer operation, including managing execution of processes, memory allocation, file input and output (I/O), and device I/O. One or more application programs, such as a client application software or “Application Program(s)” 204 into memory 104 for execution by the software system 200. For instance, when the system 100 is employed to control a desktop machine, application program 204 may include an e-mail client 206 (e.g., Microsoft Outlook), as shown. When the system 100 is employed to control a server machine, on the other hand, application program 204 includes mail server software (e.g., Microsoft Exchange server, available from Microsoft Corporation of Redmond, Wash.), including a Messaging aggregation and Distribution System of the invention.

Software system 200 includes a graphical user interface (GUI) 208, for receiving user commands and data in a graphical (e.g., “point-and-click”) fashion. These inputs, in turn, may be acted upon by the system 100 in accordance with instructions from the OS 202, or Application Program(s) 204. The GUI 208 also serves to display the results of operation from the OS 202 and application program(s) 204, whereupon the user may supply additional inputs or terminate the session. Typically, the OS 202 operates in conjunction with device drivers 210 (e.g., “Winsock” driver) and the system BIOS Microcode 212 can be provided by a conventional operating system, such as but not limited Microsoft R™ Windows XP, available from Microsoft Corporation of Redmond, Wash., Mac OS, available from Apple of Cupertino, Calif. or Linux OS, available from several vendors, including the Red Hat distribution of Linux from Red Hat, Inc. of Durham, N.C.

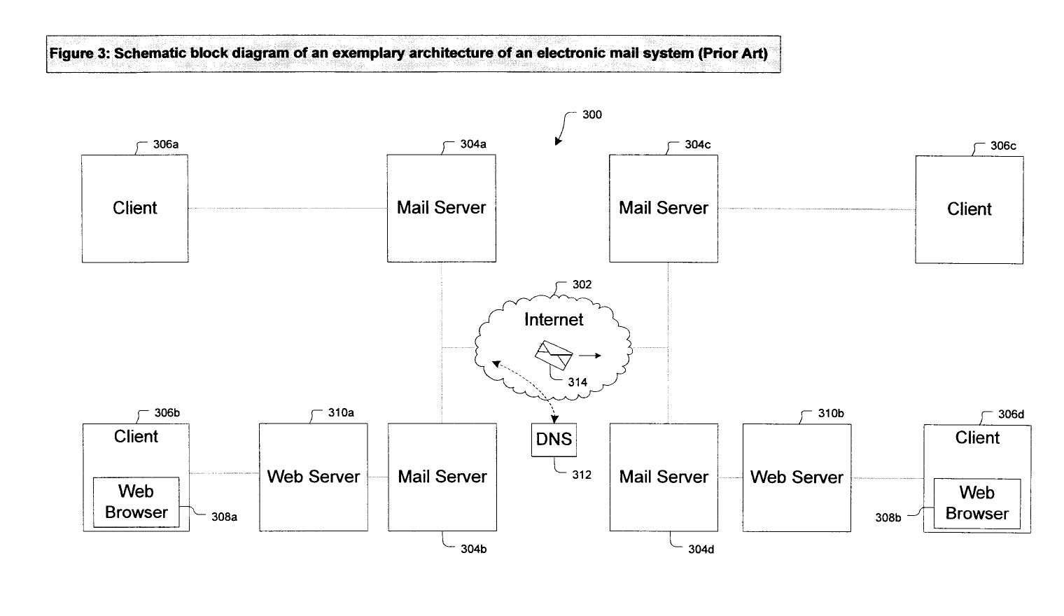

Referring now to FIG. 3, depicted is a system 300 for the delivery of e-mail messages through the Internet 302 or a similar computer network. Sending mail servers 304a, 304b, having associated source Internet protocol (IP) addresses and receiving mail servers 304c, 304d, having associated destination IP addresses or other message gateways, allow electronic messages, such as electronic mail (or “e-mail”) to be delivered to and from sending client machines 306a, 306b to receiving client machines 306c, 306d, or other devices such as cell phones, pagers, or hand-held computers. In accordance with conventional systems, the transmission direction of the e-mails may also be reversed, where the sending machines and servers become the receiving machines and servers and vice versa.

E-mail messages are typically composed by an application running on a client machine 306. When composition of the message is completed, the user uploads the completed message to a mail server 304. Another typical method for composing an e-mail message is for a user to use a web browser 308 on a client machine 306 to access a webmail user interface through a web server 310 which interfaces with a mail server 304. The mail server 304 and web server 310 in one embodiment is owned by an Internet service provider (ISP) or by a private corporation for whom a given user may be employed. The user client machine 306 connects to the mail server 304 or web server 310 via dial-up, digital subscriber loop (DSL), cable Internet, or by other appropriate means. One standard for e-mail formats is described by RFC 822 obsoleted by RFC2822, which are a standard and a proposed standard, respectively, promulgated by Internet Engineering Task Force (“IETF”). The protocol by which e-mail messages are transmitted from sending mail server 304a, 304b to receiving mail server 304c, 304d are described by RFC821, obsoleted by RFC 2821, which are also a standard and a proposed standard, respectively, of the IETF. These standards can be found at www.ietf.org. The disclosure hereby incorporates by reference the subject matter of the RFC 821 and RFC 822 standards and the RFC 2821 and RFC2822 proposed standards. If the proposed standards are updated from the versions published in April 2001, it is the subject matter of the April 2001 versions of these proposed standards that is hereby incorporated by reference. The RFC 821 and RFC 2821 documents describe a Simple Mail Transport Protocol (“SMTP”), which is the protocol by which e-mail messages have typically been transported over the Internet.

SMTP servers and SMTP clients (SMTP clients are network computers, not to be confused with the client machines 306) provide a mail transport service, and therefore act as mail transfer agents (“MTAs”). Mail user agents (“MUAs” or “UAs”) are normally thought of as the sources and targets of mail. At the source, a MUA might be the source mail server 304a, 304b that collects mail to be transmitted from a user and hands it off to an MTA within the Network 302, which may be the Internet. The final (“delivery”) MTA would be thought of as handing the mail off to a MUA, which might be the destination mail server 304c, 304d that holds a user's mail in the user's mailbox.

The SMTP mail transport protocol uses domain names to route messages from a sender to a receiver of e-mail. A distributed database of TCP/IP addresses corresponding to particular domain names is maintained across the Network 302 in domain name servers (“DNSs”) 312. Thus, to route an e-mail to its destination, the source mail servers 304a, 304b would generally take the address specified by the sending user and inquire of a DNS server 312 the IP address to be assigned to the particular addressed domain name. As used in this specification, an “address” is a character string that identifies a user to whom mail will be sent, a user or source that is sending mail, or a location into which mail will be deposited. The term “mailbox” refers to that depository. The two terms are typically used interchangeably unless the distinction between the location in which mail is placed (the mailbox) and a reference to it (the address) is important. An address normally consists of user and domain specifications; however, addresses may have different forms depending on usage and type of address. The standard mailbox naming convention is defined to be “local-part@domain”; contemporary usage permits a much broader set of applications than simple “user names”. The local part of the address is typically interpreted and assigned semantics only by the host specified in the domain part of the address. In contrast, the standard Internet Protocol (IP) address is typically a specific string of numbers identifying a source or destination server.

Once the source mail server 304a, 304b lexically identifies a domain to which e-mail will be delivered for processing, a DNS lookup, through a DNS server 312, is performed to resolve the domain name. The e-mail 314 is then sent from the source mail server 304a, 304b via the Internet 302 to the identified domain.

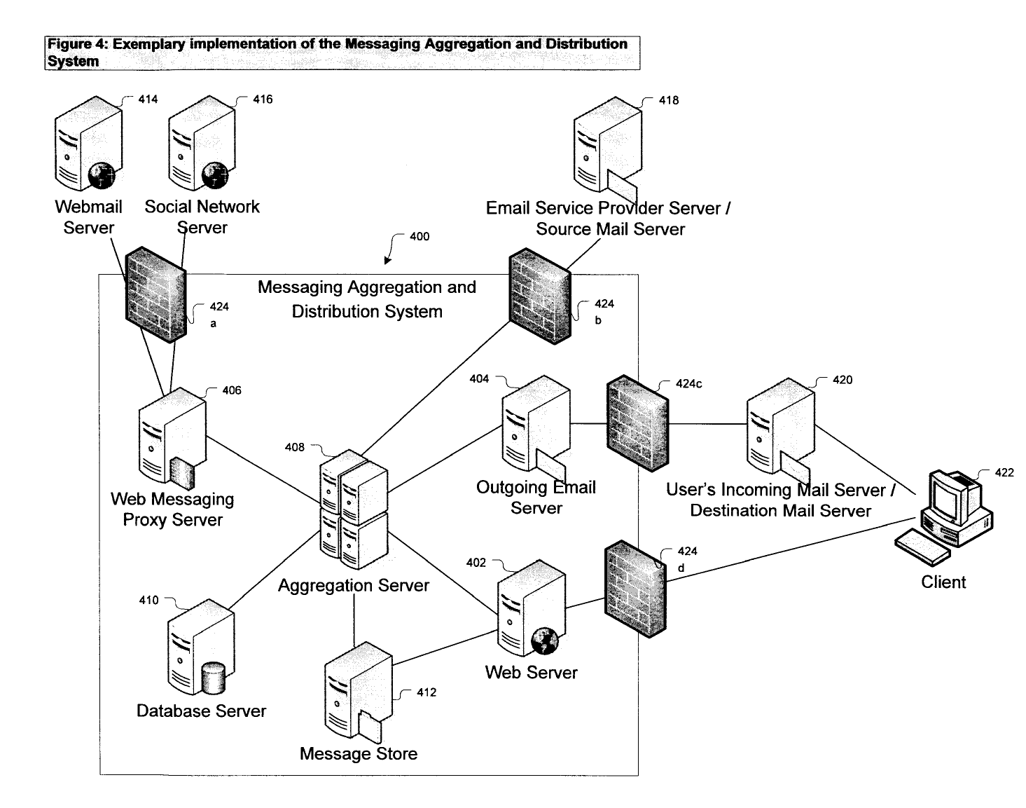

With reference now to FIG. 4, an illustrative diagram of an exemplary messaging aggregation and distribution system is illustrated. The messaging aggregation and distribution system 400 (“MADS”) may include a network of computers connected using a series of internal network connections, which provide communications links between the various server computers. The network may contain permanent wired connections utilizing, for example, either twisted pair copper cables or fiber optic cables, or may contain wireless communication connections. These connections can be made directly from server to server, or they can occur through a hub or switch device. The network may use a combination of communication protocols, including but not limited to TCP/IP and Ethernet, to manage communications between servers and other devices.

In the depicted example, several of the internal servers which may include the web server 402, outgoing e-mail server 404, web-messaging proxy server 406, and aggregation server 408 in the messaging aggregation and distribution system 400 may be connected to the Internet, a global public network of computers that communicate using TCP/IP. These systems may connect to the Internet through one or more firewall server(s) 424 which may restrict public access to the internal network and connected servers. A firewall 424 is generally a computer server or device that controls and limits communication between networks in a way that only allows specific types of communications to pass between two or more networks for the purpose of enhancing security of the computers attached to the internal network.

The connections between the internal servers, which may include the web server 402, outgoing e-mail server 404, web-messaging proxy server 406, aggregation server 408, database server 410 and message store 412 as well as the firewall server(s) 424, can communicate using the same types of connections and communications protocols as described above. The firewall server(s) 424 communicate with external servers, which may include webmail server(s) 414, social network server(s) 416, e-mail service provider server(s) 418 and destination mail server(s) 420, over the public Internet using communication links as described above. The user client device 422 communicates with the destination mail server 420 containing the user's destination mailbox and with the web server 402 of the MADS 400 over the Internet using communications links as described above. Communication with the web server 402 may occur through a Firewall 424.

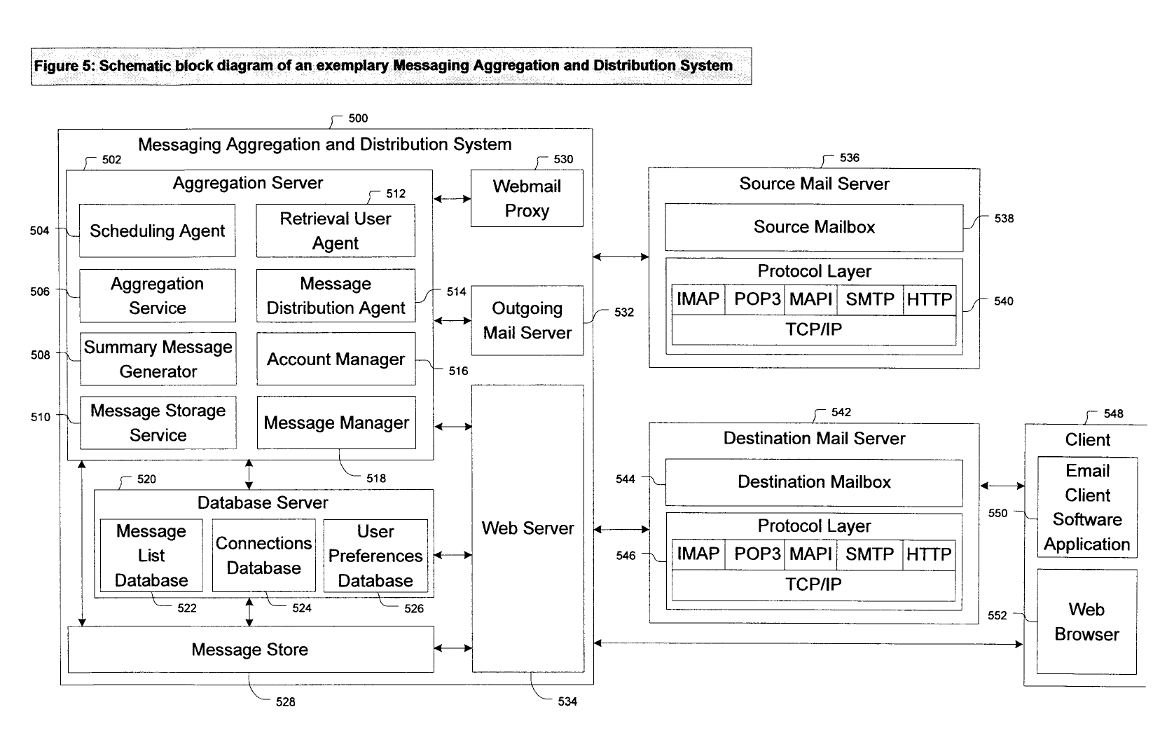

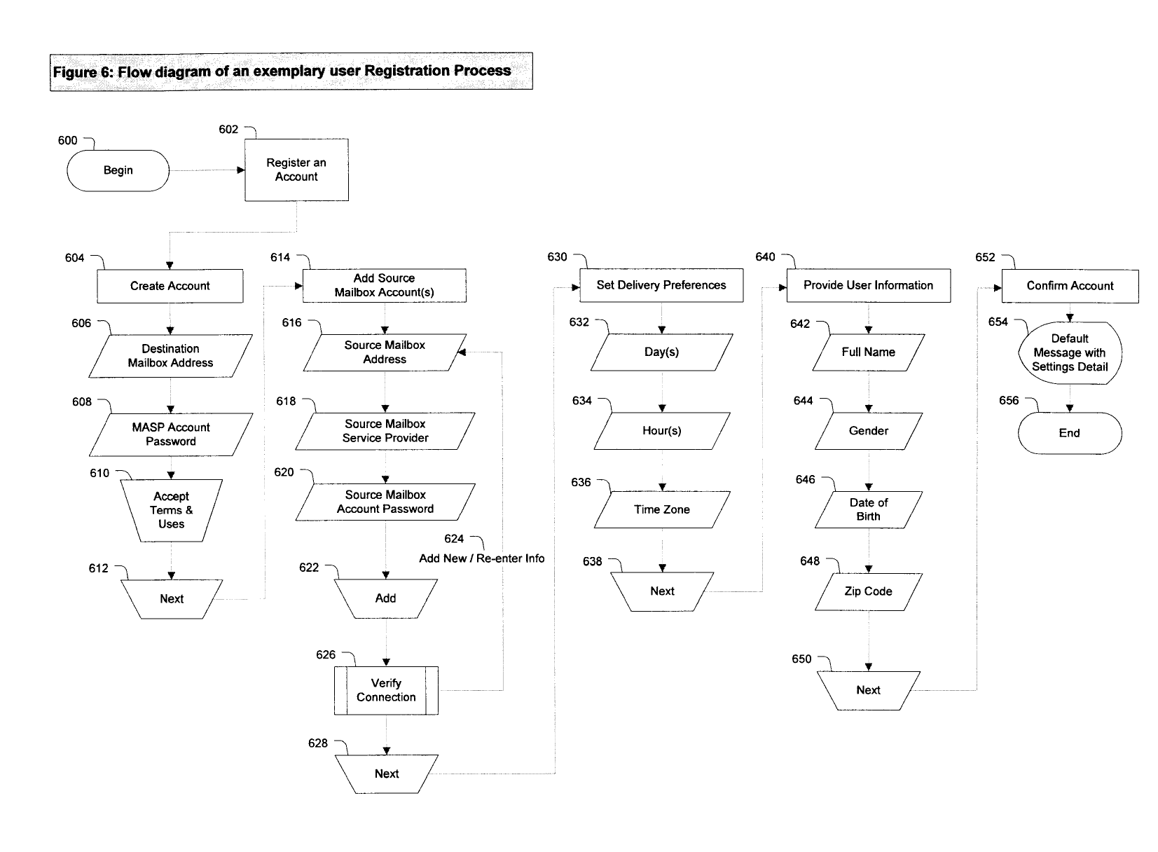

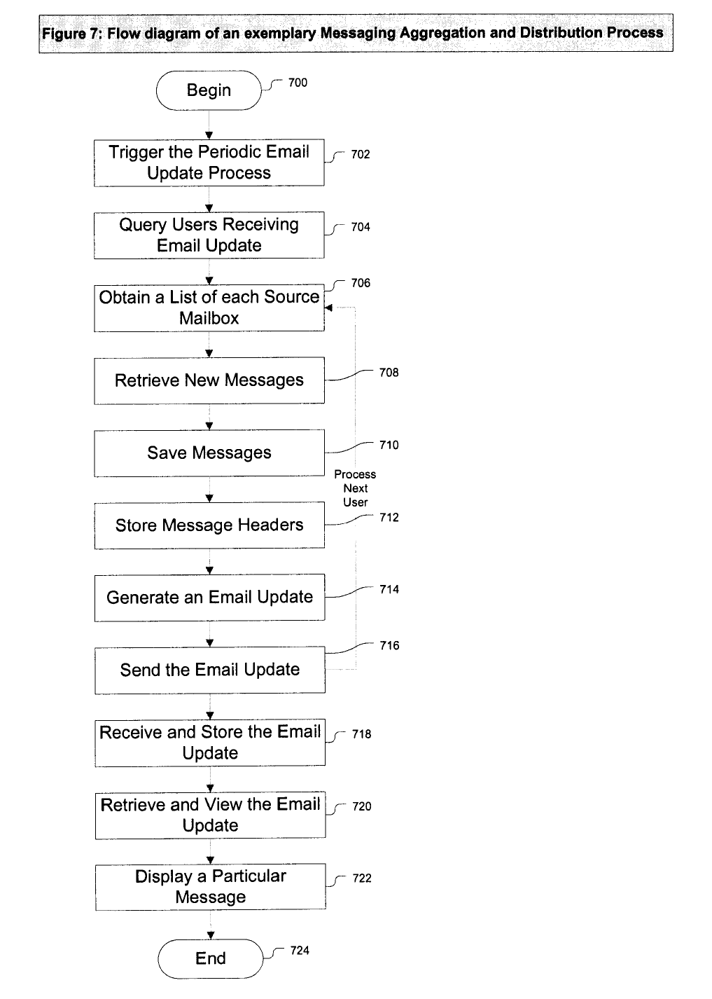

Turning now to FIG. 5, a block diagram of an exemplary message aggregation and Distribution System 500 and its components are illustrated. FIG. 5 may represent an exemplary frame of reference for describing the exemplary process flow related to the exemplary messaging aggregation and distribution system illustrated in FIG. 7 and the exemplary user registration process flow illustrated in FIG. 6.

With reference to FIG. 6, in order for a user to activate services provided by the messaging aggregation service provider, a user may be required to provide certain information, credentials and account settings so that the MASP may commence the processes associated with the messaging aggregation and delivery system 500. This process is described and discussed with reference to both FIG. 5 and FIG. 6.

To begin the registration process 600 a user may use a client computing device 548 such as a personal computer to access the MASP website located on the Internet via a web browser 552. The user may select to initiate services by selecting to register an account 602, which will begin the registration process. During the registration process a user may be required to: Create Account 604; Add Source Mailbox Accounts 614; Set Delivery Preferences 630; Provide User Information 640; and Confirm Account 652

For the process of Creating an Account 604, a user may be required to provide his/her destination mailbox address 606 and create a unique MASP account password 608. The destination mailbox address may be the address where the MASP sends the e-mail update. The MASP account password may be the credential required by the MASP for the user to manage his/her MASP account settings. A user may also be required to accept certain terms and uses 610 associated with use of the MASP's services. The user may select a navigation tool, which may contain the name “Next” 612, which may direct the user to the next step in the registration process. At this point, the information provided by the user in the Create Account 604 process will be sent through the web server 534 to be received by the database server 520 and stored in the user preferences database 526.

For the Add Source Mailbox Account(s) 614 process, a user may be required to provide a particular source mailbox address 616, select the name of the source mailbox service provider 618 from a list of supported providers and provide the source mailbox account password 620 associated with the particular source mailbox account. The information associated with the particular source mailbox account may be used by the MASP to retrieve messages on behalf of the user and aggregated into the e-mail update. A user may be required to select a navigation tool, which may contain the name “Add” 622 so that the MASP may recognize the information associated with the particular source mailbox account.

The initial information and credentials provided by the user in the Add Source Mailbox Account(s) 614 process for the particular source mailbox will be sent through the web server 534 to be received by the database server 520 and stored in the user preferences database 526. The account manager 516 may send a command through the aggregation server 502 to the database server 520 to retrieve from the connection database 524 a predefined connection ID and parameters associated with the particular source mailbox server 536 and send that information through the database server 520 to the aggregation server 502. If an associated connection ID and parameters cannot be located for the particular source mailbox server 536, a command will be sent through the database server 520 to the web server 534 to notify the user and request additional information which may include but is not limited to the incoming POP3 or IMAP server address and port number associated with the particular source mailbox server 536. Then utilizing the information and credentials provided by the user and the connection parameters or incoming server address and port number associated with the particular source mailbox server 536, the account manager 516 may send a command to the aggregation server 502 to verify the connection between the particular source mailbox server 536 and the aggregation server 502 using the user retrieval agent 512.

If the connection succeeds, the user will be notified and may repeat the process associated with Add Source Mail Account(s) 614 process for each source mailbox 538 the user wishes to provide. If the connection fails, a user may be required to re-enter information 624 or credentials related to a particular source mailbox 538 located on an associated source mailbox server 536. Once a user has provided information associated with any number of source mailbox accounts and all connections have been verified, the user may be required to select a navigation tool, which may contain the name “Next” 628, which may direct the user to the next step in the registration process.

For the Set Delivery Preferences 630 process, a user may be required to select the day(s) 632, hour(s) 634 and associated time zone 636 so that the MASP may determine when and how often to deliver the e-mail update to the user's destination mailbox 544. Once a user determines the day(s) 632, hour(s) 634 and associated time zone 636, the user may be required to select a navigation tool, which may contain the name “Next” 638, which may direct the user to the next step in the registration process. At this point, the information provided by the user in Set Delivery Preferences 630 process may be sent through the web server 534 to be received by the database server 520 and stored in the user preferences database 526.

For the Provide User Information 640 process, a user may be required to provide certain personal information, which may include but is not limited to the user's full name 642, gender 644, date of birth 646 and zip code 648. Once a user provides the personal information, the user may be required to select a navigation tool, which may contain the name “Next” 650. At this point, the information provided by the user in Provide User Information 640 process may be sent through the web server 534 to be received by the database server 520 and stored in the user preference database 526.

For the Confirm Account 652 process, a user may view a message that summarizes the user-submitted information, credentials and settings 654. If the information displayed is correct, the user may select a navigation tool, which may contain the name “Confirm” 656. At this point, the user has completed the account activation process 656 and may expect to receive his/her e-mail update per the user-defined settings. It should be noted that a user may change at any time their preferences, as specified during the user registration process 600 by accessing the MASP website and selecting a navigation tool which may contain the name “Edit My Account.”

Now turning to FIG. 7, a process flow diagram of the periodic aggregation and distribution process for an individual user is read in accordance to the delivery preferences specified during the user registration process in FIG. 6 and stored within the user preferences database in accordance with FIG. 5. This particular example may define the process for an individual user; however, those skilled in the art may appreciate that the process may run contemporaneously for any number of users.

The aggregation and distribution process begins 700 automatically within the MADS 500 by means of a scheduled service managed by a scheduling agent 504 within the aggregation server 502. The scheduling agent 504 may trigger the periodic e-mail update process 702 by initiating the aggregation service 506. The scheduling agent 504 runs on a predefined schedule that corresponds with the scheduling options available to the user during the Set Delivery Preferences 630 process of the registration process 600. This schedule may be defined, for example, as once an hour every hour of each day.

In order to determine all users set to receive an e-mail update for a current period of time, in accordance with their specified delivery preferences, the aggregation service 506 may query users receiving an e-mail update 704 as defined in the user preferences database 526 on the database server 520 for all users defined to receive an e-mail update for the current period. The query request is sent to the database server 520 which retrieves the relevant information from the user preferences database 526 and returns the information to the aggregation service 506 in a structured format, such as Extensible Markup Language (“XML”). For each user scheduled to receive an e-mail update, the relevant information returned may include the particular user's full name 642, destination mailbox address 606, and user associated time zone 636 as defined in the user registration process 600. The aggregation service 506 may then obtain a list of each source mailbox 706 associated with each user as specified during the user registration process 600. The account preferences for each source mailbox 538 may include the connection ID and parameters for the associated source mail server 536, the user's account address 616, source mailbox account password 620, and the timestamp which may indicate the last time messages were successfully retrieved from the particular source mailbox 538.

Once a detailed list of users and associated information as described above is obtained, the aggregation service 506 may retrieve new messages 708 from the associated source mail server(s) 536 for each user in the list. Starting with the first user on the list, the aggregation service 506 may obtain connection details for each source mailbox 538 associated with the user. The aggregation service 506 may use the associated connection ID and parameters to return connection details from the connection database 524, which may include the name of the source mailbox service provider, a URL link to the provider's messaging login page, a URL link to a logo image file, the connection type (e.g., POP3, IMAP), and the incoming server address, port number, and security settings (e.g., Secure Sockets Layer or “SSL”). For each source mailbox 538, the aggregation service 506 may utilize the retrieval user agent 512 to retrieve new messages from the associated source mailbox(es) 538.

The aggregation service 506 may pass the connection details to the retrieval user agent 512 which may determine how to establish a connection with the source mail server 536. The source mail server 536 may have a protocol layer 540 which may allow access to the messages within the user's source mailbox 538 using one or more protocols (e.g., IMAP, POP3, MAPI, HTTP). The retrieval user agent 512 may establish a connection over the Internet utilizing one of those protocols to obtain all new messages contained within the source mailbox 538. For webmail providers (e.g., Gmail, Hotmail), the retrieval user agent 512 may utilize a webmail proxy 530 (e.g., FreePOPs, an open-source product made available through SourceForge.net) which may establish an HTTP connection to the source mail server 536 over a TCP/IP Internet connection and emulate a POP3 source mailbox 538 for the retrieval user agent 512 to access the messages in a similar fashion as a direct connection to a source mail server 536 providing a POP3 connection or the like.

After retrieving all new messages from a given source mailbox 538, the retrieval user agent 512 may activate the message storage service 510 to save messages 710 in the message store 528. Each message may be converted into a file that may be viewable in a web browser, such as a Hyper Text Markup Language (HTML) file, and stored in the message store 528. The message storage service 510 may then store message headers 712 in the message list database 522, the details of which may include the sender name and address, timestamp when the messages was received by the associated source mail server 536, subject line, and the filename and location where the message was saved in the message store 528. Each message may be stored within the message list database 522 either in place of or in addition to being stored in the message store 528. An exemplary messaging retrieval process, shown in FIG. 7, is considered complete for a given user once all messages from the user's subscribed source mailboxes 538 are retrieved and saved or after a defined timeout period that may be caused by abnormal events that may include unavailable connections, service outages, or improper login credentials. After all messages are retrieved and saved, the connection with the source mail server 536 may be closed.

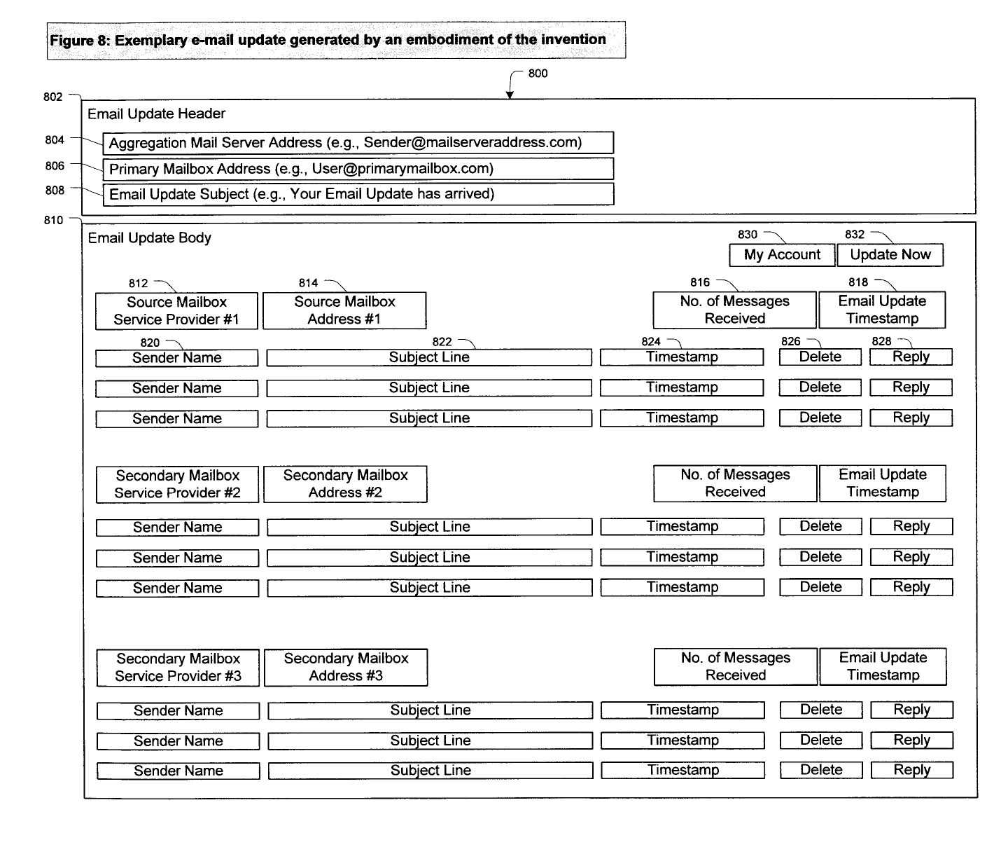

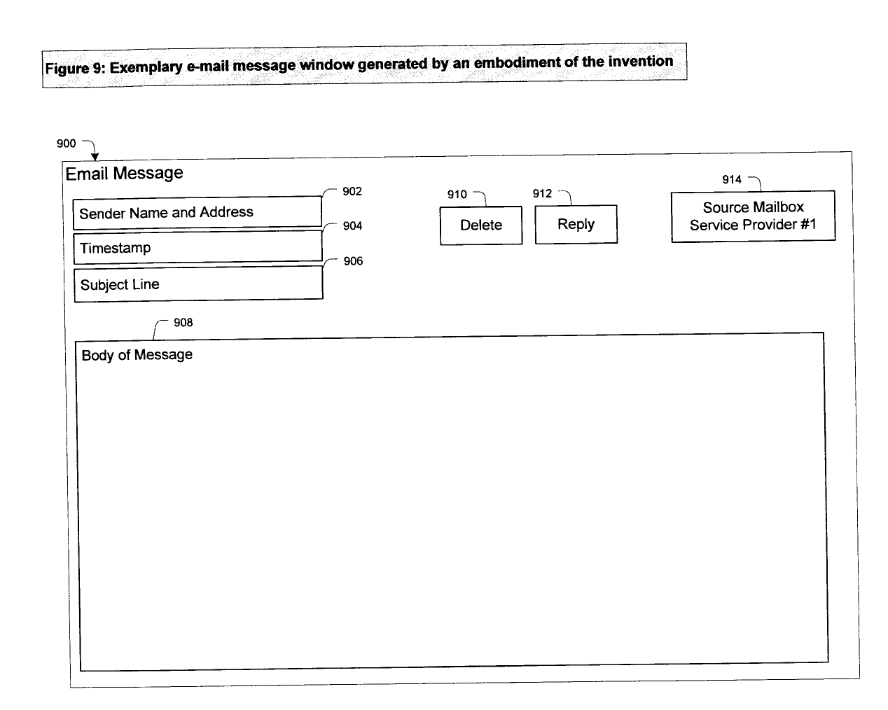

Once all messages for a given user have been retrieved, the summarization of the messages and subsequent distribution of the aggregated messages as an e-mail update may begin. It is helpful to now present FIG. 8 representing an exemplary embodiment of an e-mail update and FIG. 9 representing an exemplary embodiment of an e-mail message display as a frame of reference.

To begin the summarization of the messages and subsequent distribution of the aggregated messages as an e-mail update 800, the aggregation service 506 initiates the summary message generator 508 in order to generate an e-mail update message 714 for a given user. The e-mail update 800 may contain a list of all the new messages retrieved from the user's source mailbox 538 with details which may include sender name 820 (which may contain a hyperlink to the sender's e-mail address), subject line 822 (which may contain a hyperlink to the e-mail message 900 which may be stored in the message store 528 and accessed through the web server 534 to be viewed in a web browser 552), timestamp 824, the name of the source mailbox service provider 812 (which may contain a hyperlink to the source mailbox service provider website) and the name of the source mailbox address 814 (which may also contain a hyperlink to the source mailbox service provider website).

Once the e-mail update 800 has been generated, it may be passed to the message distribution agent 514, which may send the e-mail update 716 to a particular user's destination mailbox 544 through the outgoing mail server 532. The outgoing mail server 532 may use SMTP to send the e-mail update 800 to the user's destination mail server 542, which may then receive and store the e-mail update 718 in the user's destination mailbox 544 for future retrieval by the user. The destination mail server 542 may give the user access to the destination mailbox 544 by way of one or more protocols within its protocol layer 546 (e.g., IMAP, POP3, MAPI, HTTP). The user may retrieve and view the e-mail update 720 by accessing the e-mail update 800 located in the destination mailbox 544 using a client 548 computer that may be running an e-mail client software application 550 or via a web browser 552 communicating over the Internet using TCP/IP. The user may display a particular message 722 in a web browser 552 by selecting a hyperlink which may be embedded in the subject line 822 of the particular message. When a user selects a particular hyperlink, the user's web browser 552 may be directed to the web server 534, which may retrieve the e-mail message 900 of the associated message from the message store 528.

In addition, to the functionally related to the e-mail update 800 as described above, a user may have the option to delete any of the aggregated messages from the source mailbox 538 associated with the particular message, reply to the sender associated with the particular message through the mail user agent associated with the user's destination mailbox 544, automatically redirect to a webmail client associated with a particular source mail server 536, and request a new e-mail update 800 to be generated and sent to the user's destination mailbox 544 in addition to the regularly scheduled delivery times.

To delete a particular message from its source mailbox 538, a user may select a navigation tool that may contain the name “Delete,” 826 which may result in that particular message being removed from the source mailbox 538. The navigation tool containing the name “Delete” may also be selected through the e-mail message display 900 as reed by the delete navigation tool 910. When a user selects delete 826 or 910 a command is sent through the web server 534 to the message manager 518 which then utilizes the retrieval user agent 512 to remove the message from the associated source mailbox 538.

To reply to a sender associated with a particular message, a user may select the navigation tool that may contain the name “Reply,” 828, 912 which will create a new message in the user's destination mailbox 544 client with the e-mail address associated with the sender of the particular message populated in the “To” or “Recipient” field. The new message may be sent through the user's destination mail server 542 as reed by the e-mail system process described in FIG. 3.

To automatically be redirected to a particular source mailbox webmail client, a user may select a hyperlink containing the name of the particular source mailbox 812 account or the associated source mailbox address 814, which may direct the user to a specific URL in a web browser 552 that will directly log the user into the webmail client associated with a particular source mailbox 812.

To request a new e-mail update 800 to be sent to a user's destination mailbox 544 in addition to the regularly scheduled delivery times, a user may select a navigation tool that may contain the name “Update Now,” 832 which may send a command to the retrieval user agent 512 to send a new e-mail update, which may contain a list of messages most recently received by the associated source mail server(s) 536 in accordance to the process as described in FIG. 7.

In addition to accessing e-mail messages through the sent e-mail update 800, a user may also have the ability to display a summary of the aggregated messages directly through the MASP website, which may be accessed through the web server 534 and displayed through a web browser 552 on the user's client 548 computer. The displayed messages may be retrieved from the message list database 522 by way of the message manager 518. The message manager 518 may allow the user to activate the aggregation service 506 to retrieve the most recent messages available from the source mailbox(es) 538 in accordance with the process as described in FIG. 7. The message manager 518 may also allow the user to delete messages from a source mailbox 538 by way of the retrieval user agent 512.

Lastly, a user may have the option to change or edit his/her MASP account settings by directly logging into the MASP website and selecting a navigation tool which may contain the name “My Account.” The user may also be directed to the My Account webpage by selecting the navigation tool “My Account” 834 located in the e-mail update 800. Any modifications to the user settings will be recorded and stored in the user preference database 526.

While the foregoing is directed to exemplary embodiments of the present invention, other and further embodiments of the invention may be devised without departing from the basic scope thereof, and the scope thereof is determined by the claims that follow.

What is claimed is:

1. A method for aggregating and delivering electronic messages, comprising:
periodically retrieving electronic messages associated with a single user from a plurality of source electronic mail servers via an aggregation server;
storing the retrieved messages from the plurality of source electronic mail servers in an aggregated message store;
generating an aggregated electronic mail message containing an aggregated list of the retrieved messages; and
delivering the aggregated electronic mail message to a single destination mailbox for retrieval by the user as a single e-mail message, wherein the aggregated electronic mail message contains at least a portion of each of the retrieved electronic messages.

2. The method of claim 1, wherein the aggregated electronic mail message further comprises at least one electronic link to original message contents for each of the electronic messages retrieved from the plurality of source electronic mail servers.

3. The method of claim 1, wherein the retrieving and storing operations are conducted on a recurring basis.

4. The method of claim 1, further comprising synchronizing the plurality of source electronic mail servers with the aggregated message store based upon a status of the retrieved messages.

5. The method of claim 4, wherein the status of the retrieved messages includes whether the retrieved message is at least one of read, unread, deleted, or saved.

6. The method of claim 1, wherein the generating and delivering of the aggregated electronic mail message are conducted on a recurring basis as defined by the user.

7. A communications system for aggregating electronic messages, comprising:
a website configured to allow a user to enroll in an aggregation service;
a plurality of source mailboxes and a plurality of source mail servers containing messages associated with a plurality of source e-mail accounts associated with the user;
an aggregation server configured to periodically or on command retrieve user messages from the plurality of source message servers;
a webmail proxy configured to retrieve messages or send messages utilizing HTTP protocol;
a message store configured to store aggregated messages retrieved from the plurality of source mailboxes;
a database server configured to maintain user preferences, source mail server connection parameters, and a list of message headers associated with messages retrieved from the source mailboxes;
an outgoing mail server configured to send e-mail messages to a destination mailbox address; and
a destination mailbox for the user to receive e-mail messages.

8. The communications system of claim 7, wherein the plurality of source mailboxes include mailboxes associated with e-mail messages, messages sent through social networks, messages sent as short message services, messages sent through mobile devices, transcribed voicemail messages, or visual voicemail messages.

9. The communications system of claim 7, wherein the database server comprises a user preferences database for storing user information, which includes for each user ID, a full name, destination mailbox address, account password, e-mail update delivery settings, and credentials for each source mailbox, including service provider ID, connection ID, login ID, and password.

10. The communications system of claim 7, wherein the database server comprises a connections database for defining protocol layers associated with the source mail servers, and for storing connection parameters, including server addresses, port numbers, security parameters, and login ID format.

11. The communications system of claim 7, wherein the aggregation server is configured to send and receive commands between the aggregation server, database server, any number of source mail servers, and destination mailboxes.

12. The communications system of claim 7, wherein the aggregation server comprises an account manager for retrieving information associated with any user entered by the user via a website and storing the information in the user preferences database.

13. The communications system of claim 7, wherein the aggregation server comprises a retrieval user agent for connecting with the source mail servers and retrieving messages associated with the source mailboxes as defined by the parameters stored in a user database and a connections database.

14. The communications system of claim 7, wherein the aggregation server comprises a messaging storage service configured to store messages retrieved by a retrieval user agent in the aggregated message store or message list database, and for storing message headers in a message list database associated with the database server.

15. The communications system of claim 7, wherein the aggregation server comprises a summary message generator configured to generate an aggregated electronic mail message that lists messages stored by the message storage service for a given user.

16. The communications system of claim 7, wherein the aggregation server comprises a message distribution agent configured to send an e-mail update generated by the summary message generator to a given user's destination mailbox through the outgoing mail server.

17. The communications system of claim 7, wherein the aggregation server comprises a scheduling agent running on a predefined interval to command an aggregation service to retrieve messages, store messages, generate an aggregated electronic mail message, and distribute an aggregated electronic mail message for users scheduled to receive an aggregated electronic mail message as defined by a user preferences database.

18. The communications system of claim 7, wherein the aggregation server comprises a message manager configured to command the aggregation server to delete a particular message from its associated source mailbox when a user selects a delete navigation tool.

19. An aggregated electronic mail message, comprising:
an aggregated electronic mail message containing a list of messages received from a plurality of source mail servers associated with a single user, the aggregated electronic mail message containing a plurality of navigation tools and a categorized list of aggregated electronic mail messages by the source mailbox associated with each message, and the aggregated electronic mail messages are listed in a format that includes sender name, sender e-mail address, subject line, and timestamp associated with each message; and
the subject line containing a hyperlink to redirect the user to a URL via a web browser to view a body of a particular message associated with the particular subject line, the sender name and sender e-mail address containing a “mail to” hyperlink associated with the e-mail address of the particular sender so that the user may reply to the particular sender through the destination mailbox, the source mailbox name or logo containing a hyperlink to redirect the user to a site via a web browser to view a mailbox client associated with a particular source mailbox.

20. The aggregated electronic mail message of claim 18, wherein the list of messages is configured to be delivered to any given users as an e-mail message to a particular user's destination mailbox, as a really simple syndication feed to a user's client computing device, as a web widget application to the user's client computing device, as a short message service message sent to the user's mobile communication device, or to a custom client application that can be installed on the user's computing or mobile communication device.
